(19) United States
(12) Patent Application Publication
(10) Pub. No.: US 2022/0007239 A1
(43) Pub. Date: Jan. 6, 2022

(54) HANDOVER IMPROVEMENT IN NEW RADIO UNLICENSED

(71) Applicant: MediaTek Singapore Pte. Ltd., Singapore (SG)

(72) Inventors: Abhishek ROY, San Jose, CA (US); Pavan Santhana Krishna NUGGEHALLI, San Jose, CA (US); Chia-Chun HSU, Hsinchu City (TW)

(21) Appl. No.: 17/298,660

(22) PCT Filed: Jan. 20, 2020
(86) PCT No.: PCT/US2020/014247

§ 371 Date: May 31, 2021

Related U.S. Application Data
(60) Provisional application No. 62/798,585, filed on Jan. 30, 2019.

(51) Int. Cl. H04W 36/00; H04W 36/22; H04W 36/32

(52) U.S. Cl. CPC H04W 36/0058; H04W 36/22; H04W 84/12; H04W 36/32; H04W 36/00837

(57) ABSTRACT

An efficient handover mechanism in New Radio Unlicensed (NR-U) is proposed. NR-U gNB will provide measurement object configuration and report configuration to include Received Signal Strength Indication (RSSI) or Channel Occupancy (CO) or some other channel load metrics. NR-U UE will use the measurement object configuration to measure the neighboring cells and subsequently report the measured RSSI/CO/channel load metrics of the neighboring cells to the source gNB using the report configuration. The report configuration will include Channel Utilization of the unlicensed network (e.g., WLAN) and Channel Availability of neighboring NR-U cells. This will improve the handover performance in NR-U, as a NR-U neighboring cell can be heavily loaded by different unlicensed nodes, e.g., WiFi nodes.

### CROSS REFERENCE TO RELATED APPLICATIONS

This application claims priority under 35 U.S.C. § 119 from U.S. Provisional Application No. 62/798,585, entitled “Handover Improvement in NR-U,” filed on Jan. 30, 2019, the subject matter of which is incorporated herein by reference.

### TECHNICAL FIELD

The disclosed embodiments relate generally to wireless network communications, and, more particularly, to handover improvement in 5G new radio unlicensed (NR-U) wireless communications systems.

### BACKGROUND

Third generation partnership project (3GPP) and Long-Term Evolution (LTE) mobile telecommunication systems provide high data rate, lower latency and improved system performances. With the rapid development of “Internet of Things” (IOT) and other new user equipment (UE), the demand for supporting machine communications increases exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In such a solution, an established communication protocol such as an LTE carrier can be used over the licensed spectrum to provide a fist communication link, and another LTE carrier can also be used over the unlicensed spectrum to provide a second communication link.

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). In 5G New Radio (NR), the base stations are also referred to as gNodeBs or gNBs. For UEs in RRC Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB.

Cell selection/reselection and handover in NR unlicensed (NR-U) will be different from NR. First, unlike NR, in NR-U all cells in the unlicensed spectrum might belong to different Public Land Mobile Networks (PLMNs). In licensed NR spectrum, all cells in a particular frequency belong to the same PLMN. Naturally, a UE in NR normally camps on to the strongest cell of a particular carrier. However, in unlicensed NR-U spectrum, the strongest cell of a carrier might belong to a different PLMN. Thus, it is agreed upon in 3GPP specification that in NR-U, the UE will not camp on the strongest cell, if the strongest cell does not belong to its own PLMN. Second, deployment of unlicensed spectrum might be un-planned. As a result, while camped on or connected over an unlicensed carrier in a source cell, some neighboring target cells might suffer from heavy channel load and interference from other unlicensed UEs and various network nodes including WiFi access points (APs) and WiFi stations. On the other hand, some other neighboring unlicensed cells might have a relatively low load.

A solution is sought to explore some channel load metrics (e.g. channel occupancy) of unlicensed cells during handover procedure to a neighboring cell in NR-U.

### SUMMARY

An efficient handover mechanism in New Radio Unlicensed (NR-U) is proposed. NR-U gNB will provide measurement object configuration and report configuration to include Received Signal Strength Indication (RSSI) or Channel Occupancy (CO) or some other channel load metrics. NR-U UE will use the measurement object configuration to measure the neighboring cells and subsequently report the measured RSSI/CO/channel load metrics of the neighboring cells to the source gNB using the report configuration. The report configuration will include Channel Utilization of the unlicensed network (e.g., WLAN) and Channel Availability of neighboring NR-U cells. This will improve the handover performance in NR-U, as a NR-U neighboring cell can be heavily loaded by different unlicensed nodes, e.g., WiFi nodes.

In one embodiment, a UE establishes a radio resource control (RRC) connection with a serving base station in an unlicensed network. The UE receives a measurement configuration. The measurement configuration comprises measurement objects for a list of unlicensed new radio (NR-U) channels and WLAN channels. The UE performs measurements and obtains measurement results that comprise a signal to interference and noise radio (SINR), a reference signal received power (RSRP), a reference signal received quality (RSRQ), and a channel load metric (e.g. channel occupancy) of a target cell. The UE transmits a measurement report for the measurement results to the base station for handing over the UE to the target cell.

Other embodiments and advantages are described in the detailed description below. This summary does not purport to define the invention. The invention is defined by the claims.

### BRIEF DESCRIPTION OF THE DRAWINGS

FIG. 1 illustrates an exemplary 5G new radio NR-Unlicensed (NR-U) wireless communication system that supports efficient handover procedure using channel load metrics in accordance with a novel aspect.

FIG. 2 is a simplified block diagram of a wireless transmitting device and a receiving device in accordance with embodiments of the present invention.

FIG. 3 illustrates a sequence flow between a UE and a base station in unlicensed spectrum for performing measurements and reporting for handover using RSRP/RSRQ and channel load metrics (e.g. channel occupancy) in accordance with one novel aspect.

FIG. 4 illustrates a flow chart of UE estimating and reporting channel statistics of an unlicensed network in accordance with one novel aspect.

FIG. 5 is flow chart of a method of UE performing measurements and handover procedure in 5G NR-U in accordance with one novel aspect.

### DETAILED DESCRIPTION

Reference will now be made in detail to some embodiments of the invention, examples of which are illustrated in the accompanying drawings.

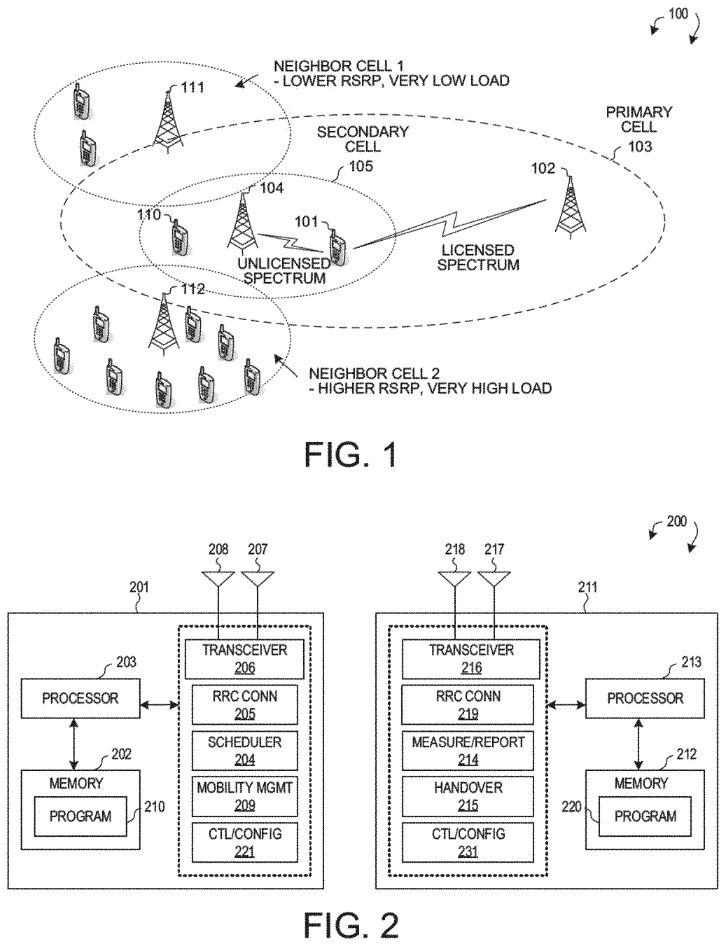

FIG. 1 illustrates an exemplary 5G new radio (NR) wireless communication system 100 that supports efficient cell selection and reselection using channel load metrics in NR-unlicensed (NR-U) in accordance with a novel aspect. 5G NR wireless communications system 100 includes one or more wireless communication networks, and each of the wireless communication networks has base infrastructure units, such as 102, 104, 111, and 112. The base infrastructure units may also be referred to as an access point, an access terminal, a base station, eNB, gNB, or by other terminology used in the art. Each of the base stations 102 and 104 serves a geographic area. The geographic area served by wireless communications stations 102 and 104 overlaps in this example.

Base station 102 is a licensed base station that communicates with UE 101 via a licensed frequency band. In one example, base station 102 communicates with UE 101 via LTE wireless communication. Base station 102 provides wireless communication to multiple UEs within primary cell 103. Base station 104 is an unlicensed base station that communicates with UE 101 via an unlicensed frequency band. In one example, base station 104 communicates with UE 101 via LTE wireless communication. Base station 104 can communicate with multiple UEs with a secondary cell 105. Secondary cell 105 is also referred to as a “small cell”. Note that, FIG. 1 is an illustrative plot. The base station 102 and base station 104 can be co-located geographically.

The exponential growth in data consumption has created large bandwidth demands that cannot be met by current wireless systems. To meet this ever-increasing demand for data, new wireless systems with greater available bandwidth are needed. Licensed Assisted Access (LAA) wireless networks can be used to provide greater available bandwidth. An LAA network utilizes unlicensed frequency bands in addition to licensed frequency bands contemporaneously, thereby provided additional available bandwidth to the UEs in the wireless system. For example, UE 101 can benefit from simultaneous use of the licensed frequency band and the unlicensed frequency band in an LAA network. The LAA network not only provides additional bandwidth for greater overall data communication, but also provide consistent data connectivity due to the presence of two separate data links. Having multiple data links available increases the probability that the UE will be able to achieve proper data communication with at least one base station at any given moment.

In NR-Unlicensed (NR-U), not only downlink channels, but uplink channels are also transmitted over the 5GHz unlicensed band. While utilization of the unlicensed spectrum provides more available bandwidth, the use of the unlicensed spectrum faces practical problems that need to be addressed. Cell selection/reselection and handover procedures in NR-U will be different from NR in two major aspects. First, unlike NR, in NR-U all cells in the unlicensed spectrum might belong to different Public Land Mobile Networks (PLMNs). Second, deployment of unlicensed spectrum might be un-planned. As a result, while connected over an unlicensed carrier in a source cell, some neighboring target cells might suffer from heavy channel load and interference from other unlicensed UEs and various network nodes including WiFi access points (APs) and WiFi stations. On the other hand, some other neighboring unlicensed cells might have a relatively low load or channel occupancy.

For UEs in Radio Resource Control (RRC) connected mode mobility, handover is the procedure through which a UE hands over an ongoing session from the source gNB (source cell) to a neighboring target gNB (target cell). Traditionally, handover decisions are made based on the measurement results on signal to interference and noise ratio (SINR), reference signal received power (RSRP) and reference signal received quality (RSRQ) of the serving cell and neighbor cells. In the example of FIG. 1, in addition to the serving cells 103 and 105, there are two neighboring cells for UE 101 and UE 110-neighbor cell 1 served by base station 111 and neighbor cell 2 served by base station 112. Neighbor cell 1 has lower RSRP, but very low load, neighbor cell 2 has higher RSRP, but very high load. Thus, it is better to explore some channel load metric to check the heavily loaded cells during handover. NR-U networks thus need to overcome more challenges than traditional NR handovers.

In accordance with one novel aspect, an efficient handover mechanism in NR-U is proposed. NR-U gNB will provide measurement object configuration and report configuration to include Received Signal Strength Indication (RSSI) or Channel Occupancy (CO) or some other channel load metrics. NR-U UE will use the measurement object configuration to measure the neighboring cells and subsequently report the measured RSSI/CO/channel load metrics of the neighboring cells to the source gNB using the report configuration. The report configuration will include Channel Utilization of the unlicensed network (e.g., WLAN) and Channel Availability of neighboring NR-U cells. This will improve the handover performance in NR-U, as a NR-U neighboring cell can be heavily loaded by different unlicensed nodes, e.g., WiFi nodes. Note that the same channel availability can be extended and included in UE's inter-RAT measurements for both NR-U and LTE cells, involving mobility to and from NR-U cells, and also mobility to and from LTE cells.

FIG. 2 is a simplified block diagram of wireless devices 201 and 211 in accordance with embodiments of the present invention. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes an RRC connection handling module 205, a scheduler 204, a mobility management module 209, and a control and configuration circuit 221. Wireless device 211 is a UE that includes a measurement module 219, a measurement reporting module 214, a handover handling module 215, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the base station 201 establishes an RRC connection with the UE 211 via RRC connection handling circuit 205, schedules downlink and uplink transmission for UEs via scheduler 204, performs mobility management via mobility management module 209, and provides measurement and reporting configuration information to UEs via configuration circuit 221. The UE 211 handles RRC connection via RRC connection handling circuit 219, performs measurements and reports measurement results via measurement and reporting module 214, performs handover via handover handling module 215, and obtains measurement and reporting configuration information via control and configuration circuit 231. In accordance with one novel aspect, UE 211 considers channel load metric (e.g. channel occupancy) of unlicensed cells in the process of performing measurements and reporting measurement results to facilitate the network to improve handover performance.

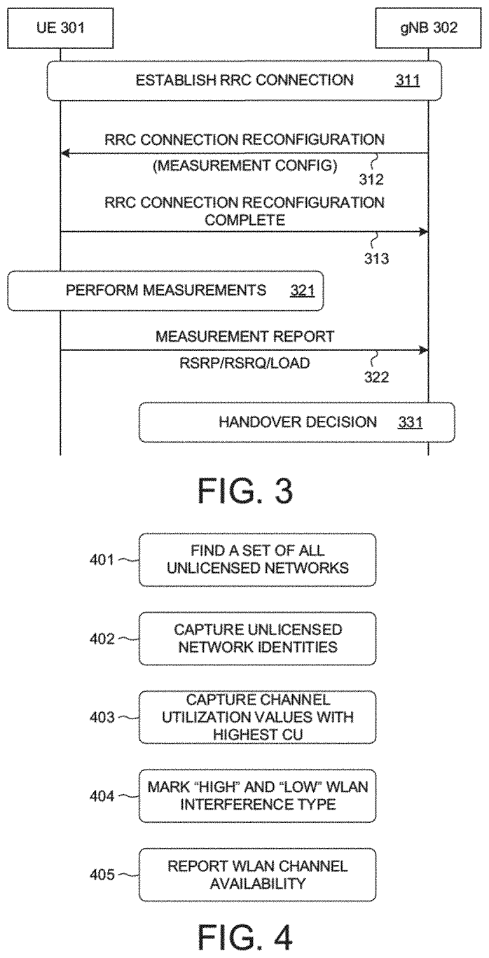

FIG. 3 illustrates a sequence flow between a UE and a base station in unlicensed spectrum for performing measurements and reporting for handover using RSRP/RSRQ and channel load metrics (e.g. channel occupancy) in accordance with one novel aspect. In step 311, UE 301 establishes a radio resource control (RRC) connection with its serving base station gNB 302 in an unlicensed network having NR-U cells and other unlicensed networks such as WLANs. After RRC connection establishment, UE 301 enters RRC connected mode and is served by gNB 302 in a serving NR-U cell. In step 312, UE 301 receives an RRC connection reconfiguration message from gNB 302 for performing channel measurements. The RRC connection reconfiguration comprises measurement configuration for both measurement object configuration and report configuration. In step 313, UE 301 sends an RRC connection reconfiguration complete message to eNB 302. In step 321, UE 301 performs measurements based on the configured measurement object configuration. In step 322, UE 301 reports measurement results to gNB 302 based on the report configuration. The measurement reporting may be triggered by EventTriggerConfig, which includes Event A1-A6. For inter-RAT handover, the measurement reporting may be triggered by ReportConfigInterRAT, which includes Event B1 and B2. Finally, in step 331, gNB 302 makes handover or inter-RAT handover decisions using the reported measurement results from UE 301.

In accordance with one novel aspect, channel measurement in NR-U will include the following parameters: 1) carrier frequency; 2) measurement bandwidth; 3) source of measurement; and 4) measurement parameters. The carrier frequency can be provided as band indicator list or carrier frequency list. In one example, band indicator list B={B₁, B₂, . . . Bₙ} represents a list of frequency bands, shared by the serving NR-U cell and any other unlicensed network. In another example, carrier frequency list F={f₁, f₂, . . . fₙ} represents a list of carrier frequency, shared by the serving NR-U cell and any other unlicensed network. Measurement bandwidth can be configured by segmenting into individual groups of physical resource blocks (PRBs), e.g., group of 10 PRBs. Source of measurement, e.g., WLANs, other NR-U cells, or any other unlicensed network, can also be included in the measurement configuration. Optionally, a list of network identifiers (e.g., WLAN SSIDs, NR-U cell IDs etc.) can be included in the measurement object. Finally, NR-U gNB will provide UE with updated parameters that need to be measured.

In NR-U, the measurement objects for NR-U cells (measObjNR) and WLAN channels (measObjWLAN) need to be enhanced. If network does not explicitly provide the list of un-licensed WLAN channels, NR-U UE needs to choose the WLAN channels for measurement. For each measurement, a layer 3 (L3) filtering will be used and the corresponding filter-coefficients, in FilterConfig of QuantityConfig, can be a single value, or specific to each different measurement. The different measurements will include channel load metric, such as Channel Occupancy (CO) or WLAN Channel Utilization, in addition to existing signal to interference and noise ratio (SINR), reference signal received power (RSRP), and reference signal received quality (RSRQ).

Specifically, The Channel Occupancy (CO) can be measured as: the rounded percentage of sample values which are beyond the “channelOccupancyThreshold” within all the sample values in the “reportInterval”. In one example, the channel occupancy equals to the percentage of measurement samples with RSSI that is higher than a threshold. WLAN Channel Utilization can be measured as: the percentage of time, linearly scaled with 255 representing 100%, that the AP sensed the medium was busy, as indicated by either the physical or virtual carrier sense (CS) mechanism. When more than one channel is in use for the BSS, the Channel Utilization field value is calculated only for the primary channel. This percentage is computed using the following formula: Channel Utilization=Integer ((channel busy time/(dotllChannelUtilizationBeaconlntervals×dot11BeaconPeriod×1024))×255), and channel busy time is defined to be the number of microseconds during which the CS mechanism has indicated a channel busy indication, dot11ChannelUtilizationBeaconlntervals represents the number of consecutive beacon intervals during which the channel busy time is measured. UE can capture these values from “BSS Load Element” field in WLAN beacons that are periodically provided by AP.

FIG. 4 illustrates a flow chart of UE estimating and reporting channel statistics of an unlicensed network in accordance with one novel aspect. In step 401, to perform various measurements and to estimate measurement results, NR-U UE will scan and find a set of all networks, operating in the frequency range, which includes the carrier frequency (fᵢ), provided by the NR-U gNB in the measurement object. For example, for any un-licensed network j, if CFⱼ and BWⱼrepresent the center frequency and the bandwidth respectively, then NR-U UE will scan and find a set of un-licensed networks (Net-U) using the following relation:

Net-U_Set={NET-Uⱼ}, such that CFⱼ−BWⱼ≤fᵢ≤CFⱼ+BWⱼ, for all f ∈F, F ∈B, 0≤j≤N

NR-U UE will estimate channel statistics summary of the set of un-licensed network (Net-U), operating in the frequency range, which includes the mentioned carrier frequency fᵢ, using the following steps. In step 402, UE will capture a list of un-licensed network identifiers (e.g. SSIDs of WLANs and unique MAC Ids) from beacons. In step 403, UE will capture the list of WLAN channel utilization values (CUⱼ), from any WLAN j, as mentioned in IEEE 802.11 standards, use L3 filtering over utilization and also mark the highest channel utilization value (CUₘ) obtained from a specific WLAN:

CUₘ=Max[CUj], for all 0≤j≤Num. of WLANs

Alternatively, UE can also capture a list of all WLAN operating across all the frequencies in that band and capture the highest channel utilization (Wm) of entire frequency band.

CUM=Max[CUⱼ^{f}^{ᵢ}], for all 0≤j≤Num. of WLANs, for all fᵢ ∈B

In step 404, if WLAN's channel utilization metric is higher than a pre-defined threshold (Thresh₁), UE will mark the corresponding WLAN's interference type as “High”, otherwise UE will mark WLAN's interference as “Low”.

$$WLAN Intfj = \{ \begin{matrix}Low , if CUj < Thresh 1 , 0 \leq j \leq Num . of WLANs \\ High , otherwise\end{matrix}$$

UE will also combine all the WLAN interference types (“High” or “low”) to estimate an “Overall WLAN Interference Type” in the specific carrier frequency. If majority of the WLAN interference are “Low”, the “Overall WLAN Interference Type” will be Low, otherwise the “Overall WLAN Interference Type” will be “High”.

$$WLAN Intf . = \{ \begin{matrix}\begin{matrix}Low , if Card [ {CU}_{j} < {Thresh}_{1} ] > Card [ {CU}_{j} \geq {Thresh}_{1} ] , \\ 0 \leq j \leq Num . of WLANS\end{matrix} \\ High , otherwise , where Card represents cardinality\end{matrix}$$

Alternatively, UE can also combine all the WLAN interference types (“High” or “low”) to estimate an “Overall WLAN Interference Type” in the entire band using the same procedure as mentioned above.

In step 405, UE will report these estimated Channel Occupancy and/or WLAN Interference and/or WLAN Channel Utilization periodically or based on existing events configured by NR-U gNB. Note that the major list of the report triggering events, such as Event A1-A6 and B1-B2, will also incorporate the channel occupancy and/or WLAN channel utilization. In NR-U measurement reports, “MeasTriggerQuantity” and “MeasReportQuantity” of measurement events will include Channel Occupancy or Channel Availability, where Channel Availability is measured as 100%-Channel Occupancy, where Channel Occupancy is measured as percentage of samples, when RSSI is above the configured Channel Occupancy Threshold. The same channel occupancy or channel availability can be included in Inter-RAT measurements, involving NR-U (e.g. NR-U to NR/LTE HO). UE in NR-U cells will report channel availability, which the NR-U gNB can use for Inter-RAT HO to less loaded, neighboring NR or LTE cells. Similarly, during handover from NR/LTE cells to target NR-U cells, the channel occupancy of the target NR-U cells will also be considered and Inter-RAT handover to highly loaded target NR-U cells will be avoided.

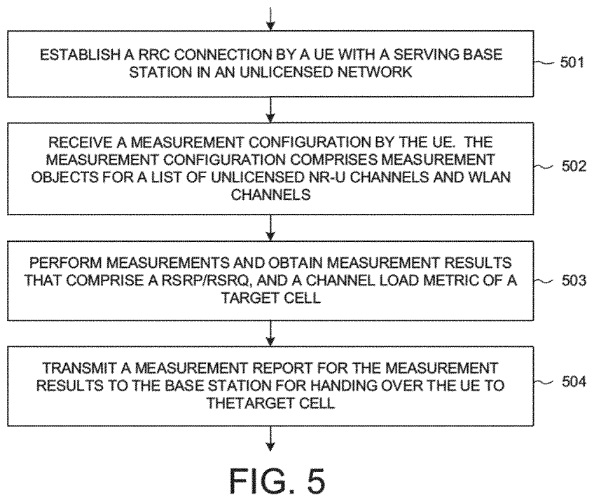

FIG. 5 is flow chart of a method of UE performing measurements and handover procedure in 5G NR-U in accordance with one novel aspect. In step 501, a UE establishes a radio resource control (RRC) connection with a serving base station in an unlicensed network. In step 502, the UE receives a measurement configuration. The measurement configuration comprises measurement objects for a list of unlicensed new radio (NR-U) channels and WLAN channels. In step 503, the UE performs measurements and obtains measurement results that comprise a signal to interference and noise radio (SINR), a reference signal received power (RSRP), a reference signal received quality (RSRQ), and a channel load metric for a target cell. In step 504, the UE transmits a measurement report for the measurement results to the base station for handing over the UE to the target cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establish a radio resource control (RRC) connection by a user equipment (UE) with a serving base station in an unlicensed network;
receiving a measurement configuration by the UE, wherein the measurement configuration comprises measurement objects for a list of unlicensed new radio (NR-U) channels and WLAN channels;
performing measurements and obtaining measurement results that comprise a reference signal received power (RSRP) and/or a reference signal received quality (RSRQ), and a channel load metric of a target cell; and
transmitting a measurement report for the measurement results to the base station for handing over the UE to the target cell.

2. The method of claim 1, wherein the measurement configuration comprises at least one of a list of frequency band, a list of carrier frequency, a measurement bandwidth, and an identity of a to-be-measured NR-U or WLAN channel.

3. The method of claim 1, wherein the channel load metric is estimated based on a received signal strength indication (RSSI) or a channel occupancy (CO) of a cell.

4. The method of claim 1, wherein the channel load metric is estimated based on a WLAN channel utilization for a corresponding WLAN channel.

5. The method of claim 1, wherein the channel load metric is estimated based on a channel availability of a corresponding neighboring NR-U cell.

6. The method of claim 1, wherein UE also receives a report configuration from the base station, wherein the report configuration comprises a WLAN channel utilization of each WLAN channel and a channel availability of each neighboring NR-U cell.

7. The method of claim 6, wherein the measurement results comprise the WLAN channel utilization and the channel availability that are piggybacked with other measurement results.

8. The method of claim 6, wherein the measurement report further comprises summary statistics of the unlicensed network, including a highest WLAN channel utilization and a WLAN interference type in a measurement band.

9. The method of claim 1, wherein both the measurements and reporting are triggered based on channel availability of neighboring NR-U cells.

10. The method of claim 1, wherein channel availability measurements are included in inter-radio access technology (inter-RAT) measurements for mobility to and from NR-U cells and LTE cells.

11. A User Equipment (UE), comprising:
a radio resource control (RRC) connection handling circuit that establishes an RRC connection with a serving base station in an unlicensed network;
a receiver that receives a measurement configuration by the UE, wherein the measurement configuration comprises measurement objects for a list of unlicensed new radio (NR-U) channels and WLAN channels;
a measurement circuit that performs measurements and obtaining measurement results that comprise a reference signal received power (RSRP) and/or a reference signal received quality (RSRQ), and a channel load metric of a target cell; and
a transmitter that transmits a measurement report for the measurement results to the base station for handing over the UE to the target cell.

12. The UE of claim 11, wherein the measurement configuration comprises at least one of a list of frequency band, a list of carrier frequency, a measurement bandwidth, and an identity of a to-be-measured NR-U or WLAN channel.

13. The UE of claim 11, wherein the channel load metric is estimated based on a received signal strength indication (RSSI) or a channel occupancy (CO) of a cell.

14. The UE of claim 11, wherein the channel load metric is estimated based on a WLAN channel utilization for a corresponding WLAN channel.

15. The UE of claim 11, wherein the channel load metric is estimated based on a channel availability of a corresponding neighboring NR-U cell.
